(19) United States
(12) Patent Application Publication
(10) Pub. No.: US 2023/0158742 A1
(43) Pub. Date: May 25, 2023

(54) HIGH SPEED ADDITIVE MANUFACTURING APPARATUS

(71) Applicant: National Taiwan University of Science and Technology, Taipei (TW)

(72) Inventors: Jeng-Ywan Jeng, Taipei (TW); Chih-Hua Hsieh, Taipei (TW); Hou-Ching Lee, Taipei (TW); Yi-Chia Chen, Taipei (TW); Shaou-Chi Liu, Taipei (TW); Tzu-Yu Hsieh, Taipei (TW); Zhi-Kai Huang, Taipei (TW)

(21) Appl. No.: 17/853,899

(22) Filed: Jun. 29, 2022

(30) Foreign Application Priority Data
Nov. 19, 2021 (TW) 110143089

(51) Int. Cl. B29C 64/282; B29C 64/153; B29C 64/273; B29C 64/218; B29C 64/286; B29C 64/236; B33Y 30/00

(52) U.S. Cl. CPC B29C 64/282; B29C 64/153; B29C 64/273; B29C 64/218; B29C 64/286; B29C 64/236; B33Y 30/00

(57) ABSTRACT

A high-speed additive manufacturing apparatus includes a main body, a sintering module, a product carrying member, a raw material carrying member, and a raw material wiper. The main body includes a printing tank and a raw material tank adjacent to the printing tank. The sintering module is arranged on the main body. The sintering module includes a plurality of sintering light source assemblies. Each of the sintered light source assemblies has a light beam emitting end. The light beam emitting end emits a sintering light beam. The light beam emitting ends of the sintering light source assemblies are arranged in a plurality of rows. Each light beam emitting end in one row is unaligned with the light beam emitting end in adjacent rows along a direction in which the light beam emitting end moves.

### CROSS REFERENCE TO RELATED APPLICATIONS

The present application claims the benefit of Taiwanese Patent Application No. 110143089 filed on Nov. 19, 2021, the contents of which are incorporated herein by reference in their entirety.

### BACKGROUND OF THE INVENTION

### Field of the Invention

The invention relates to an additive manufacturing apparatus, and more particularly to a high-speed additive manufacturing apparatus including a two-dimensional array of light sources having unaligned arrangement in adjacent rows for performing a high-speed additive manufacturing process.

### Description of the Related Art

An additive manufacturing technology (also named three-dimensional printing) is a process that includes the following steps: constructing a three-dimensional model of a product, dividing the three-dimensional model into multiple horizontal layers, and forming the product layer by layer according to the designed horizontal layers of the three-dimensional model. A product having complicated shape or high manufacturing cost produced by traditional processing methods can be manufactured by the additive manufacturing technology. Therefore, the additive manufacturing technology has been highly valued by industrial enterprises in recent years.

The additive manufacturing technology mainly includes seven kinds of processes, the fused deposition modeling (FDM), the vat photopolymerization (SLA, DLP), the powder bed fusion (SLS, DMLS), the binder jetting (3DPG), the material jetting, the laminated object manufacturing (LOM), and the direct energy deposition (DED), wherein the powder bed fusion process utilizes laser beam being spotted on raw material in a powder bed, which is also named laser sintering method including selective laser sintering (SLS) and direct metal laser sintering (DMLS). The raw material of powder is molten by the laser beam and then solidified to form the designed shape of one layer. As the product is formed layer by layer in the powder bed, the powdery raw material provides support for the half-made product during the additive manufacturing process, and thus no support structure is needed to be designed for the three-dimensional model of the product, and thus the accomplished product has a higher strength. For the reasons above, people pay more and more attentions to the application of the additive manufacturing technology.

The conventional laser sintering method for powdery raw material uses a single laser source for sintering process, wherein the single laser source moves along a predetermined path for sintering the powdery raw material in the powder bed to form the product layer by layer. However, such a process sintering the raw material with a single laser source has a very low formation rate, and the production capability is thus considerably limited.

### BRIEF SUMMARY OF THE INVENTION

An object of the present invention is to provide a high-speed additive manufacturing apparatus including a two-dimensional array of sintering light source assemblies which moves and sinters the raw material to construct designed layers of the product at a high forming rate, thereby solving the problem of low formation rate caused by utilization of a single laser source in the conventional laser powder sintering method.

The invention provides a high-speed additive manufacturing apparatus. The high-speed additive manufacturing apparatus in accordance with an exemplary embodiment of the invention includes a main body including a printing tank and a raw material tank adjacent to the printing tank; a sintering module including a plurality of sintering light source assemblies, wherein each of the sintering light source assemblies has a light beam emitting end disposed in the main body, the light beam emitting end emits a sintering light beam, the light beam emitting end is configured to move above the printing tank along a first direction, the light beam emitting ends of the sintering light source assemblies are arranged in a plurality of rows oriented along a second direction perpendicular to the first direction, and each of the light beam emitting ends in one row is unaligned with the light beam emitting ends in adjacent rows in the first direction; a product carrying member disposed in the printing tank, wherein a product is formed on the product carrying member, and the product carrying member is configured to move along a third direction in the printing tank; a raw material carrying member disposed in the raw material tank, wherein the raw material carrying member is configured to move along the third direction in the raw material tank; and a raw material wiper configured to move in the printing tank and the raw material tank.

In another exemplary embodiment, each of the sintering light source assemblies includes a light emitting member, a light beam guiding member and an optical collimator disposed at the light beam emitting end, the light emitting member emits a light guided by the light beam guiding member to pass through the optical collimator so as to form the sintering light beam.

In yet another exemplary embodiment, each of the sintering light source assemblies further includes an adapter, the light beam guiding member includes a first guiding section connected to the light emitting member at one end, and a second guiding section connected to the optical collimator at one end, the first guiding section is connected to the adapter at the other end, and the second guiding section is connected to the adapter at the other end.

In another exemplary embodiment, the sintering module further includes a collimator holder parallel to the product carrying member, the collimator holder has a plurality of first positioning holes in which the optical collimators are disposed respectively, the first positioning holes are arranged in a plurality of rows, and each of the first positioning holes in one row is unaligned with the first positioning holes in adjacent rows in the first direction.

In yet another exemplary embodiment, the sintering module further includes a guiding member holder having a plurality of second positioning holes, each of the second positioning holes corresponds to a plurality of the first positioning holes, and each of the second positioning holes accommodates a plurality of light beam guiding members.

In another exemplary embodiment, the guiding member holder is disposed above the collimator holder, the guiding member holder includes a plurality of securing plates correspondingly disposed in the second positioning holes, the sintering module further includes a plurality of bundling members corresponding to the second positioning holes, a plurality of the light beam guiding members are bundled by one of the bundling members and disposed in one of the second positioning holes, and each of the securing plates secures one of the bundling members in one of the second positioning holes.

In yet another exemplary embodiment, the sintering module further includes a movable seat configured to move along the first direction on the main body, the collimator holder and the guiding member holder are disposed on the movable seat, the movable seat has a light-passing opening corresponding to the first positioning holes, and the raw material wiper is disposed on one side of the movable seat.

In another exemplary embodiment, the high-speed additive manufacturing apparatus further includes a control module, wherein the control module includes a controller, a plurality of converters and a plurality of driving circuits, the controller has a plurality of input-output ports, the converters are connected to the input-output ports and the driving circuits, the driving circuits drive the light emitting members, the controller outputs control signals through the input-output ports according to a timing scheme, and the control signals are converted to driving signals transmitted to the driving circuits to drive the light emitting members.

In yet another exemplary embodiment, the control signals are digital signals, and the driving signals are pulse width modulation signals.

In another exemplary embodiment, the high-speed additive manufacturing apparatus further includes a position detector disposed in the main body and configured to detect a position of the light beam emitting end and generate a detecting signal transmitted to the controller, the controller generates the control signals according to the detecting signal.

The high-speed additive manufacturing apparatus of the present invention includes a two-dimensional array of sintering light source assemblies of which the light beam emitting ends in adjacent rows are unaligned, and the light beam emitting ends can scan multiple linear regions constituting one designed layer. After the two-dimensional array of the light beam emitting ends of the sintering module moves along the first direction only in one stroke, one designed layer of the product is accomplished. Therefore, the product is manufactured by the high-speed additive manufacturing apparatus of the present invention at a very high forming rate.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of a high-speed additive manufacturing apparatus of the present invention;

FIG. 2 is a perspective view of a portion of the high-speed additive manufacturing apparatus of FIG. 1;

FIG. 3 is a top view of FIG. 2;

FIG. 4 is a perspective view of a portion of a sintering module of the high-speed additive manufacturing apparatus of the present invention;

FIG. 5 is a schematic view of a light beam emitting end of the sintering module;

FIGS. 6 to 8 are schematic views of the light beam emitting end of the sintering module performing a sintering process for raw material;

FIG. 9 is a schematic view of a sintering light source assembly of the high-speed additive manufacturing apparatus of the present invention;

FIG. 10 is perspective view of a collimator holder and a guiding member holder disposed on a movable seat of the high-speed additive manufacturing apparatus of the present invention;

FIG. 11 is a schematic view of the collimator holder and the collimators equipped thereon of the high-speed additive manufacturing apparatus of the present invention;

FIG. 12 is a top view of FIG. 11; and

FIG. 13 is a schematic view of a controller of the high-speed additive manufacturing apparatus of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

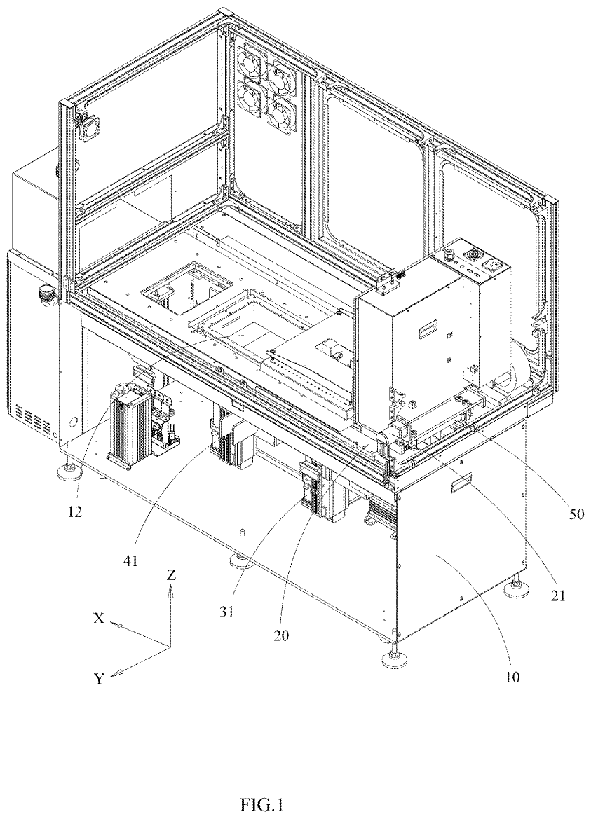

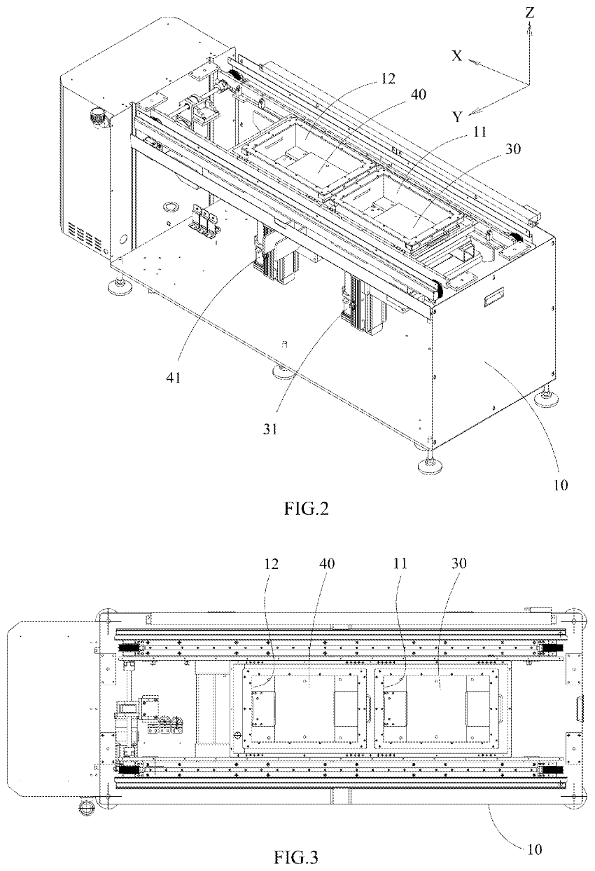

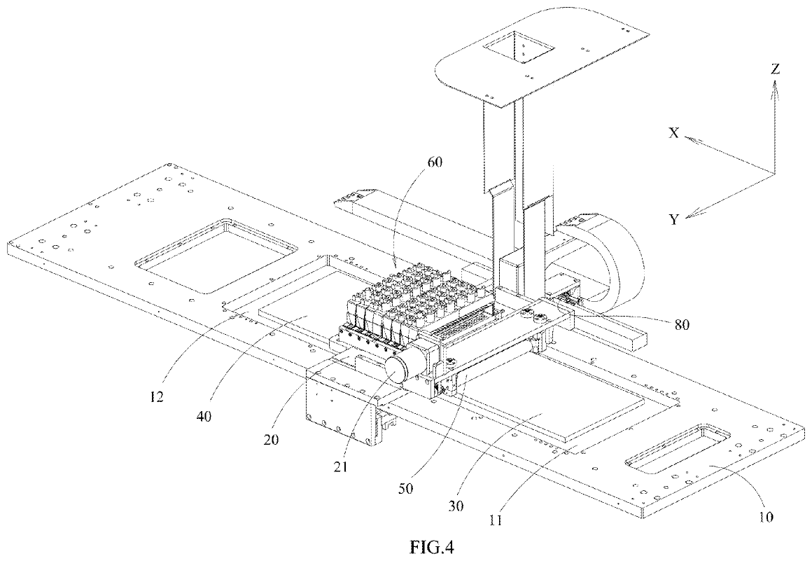

Referring to FIGS. 1, 2, 3 and 4, an embodiment of a high-speed additive manufacturing apparatus of the present invention is disclosed. The high-speed additive manufacturing apparatus of the present embodiment includes a main body 10 and a movable seat 20. The main body 10 includes a printing tank 11 and a raw material tank 12 adjacent to the printing tank 11. The printing tank 11 and the raw material tank 12 are disposed on an operation surface of a top portion of the main body 10. Powdery raw material, such as plastic powder or metal powder, is stored in the raw material tank 12. The movable seat 20 is disposed on the operation surface, and configured to move above the printing tank 11 and the raw material tank 12 along a first direction X through a first servo motor 21.

The high-speed additive manufacturing apparatus of the present embodiment further includes a product carrying member 30 and a raw material carrying member 40. The product carrying member 30 is disposed in the printing tank 11 and constitute a bottom of the printing tank 11. The product carrying member 30 is moved along a third direction Z by a second servo motor 31 disposed on a bottom of the main body 10. The raw material carrying member 40 is disposed in the raw material tank 12 and constitute a bottom of the raw material tank 12. The raw material carrying member 40 is moved along the third direction Z by a third servo motor 41 disposed on a bottom of the main body 10. The product carrying member 30 and the raw material carrying member 40 are moved in opposite directions during the additive manufacturing process. The product carrying member 30 moves downwards (in the −Z direction) as the product is formed layer by layer, whereby the powdery raw material can be supplied to spread on the printing tank 11 layer by layer. The raw material carrying member 40 move upwards (in the +Z direction) for the supplement of the powdery raw material to the printing tank 11. The high-speed additive manufacturing apparatus of the present embodiment further includes a raw material wiper 50 disposed on the movable seat 20. The raw material wiper 50 is exemplarily a powder roller disposed at one side of the movable seat 20 and moved with the movable seat 20. The raw material wiper 50 is disposed on the right side of the movable seat 20. The movable seat 20 moves across the raw material tank 12 and the printing tank 11 sequentially from the left side of raw material tank 12, whereby the raw material wiper 50 moves across the raw material tank 12 and the printing tank 11 sequentially along with the movable seat 20 to spread the powdery raw material to the printing tank 11 from the raw material tank 12.

The high-speed additive manufacturing apparatus of the present embodiment further includes a sintering module 60. The sintering module 60 includes a plurality of sintering light source assemblies 61. Each of the sintering light source assemblies 61 includes a light beam emitting end 611 disposed on the movable seat 20 and located on the right side of the raw material wiper 50. The light beam emitting end 611 is moved with the movable seat 20 above the printing tank 11 along the first direction X. When the movable seat 20 moves from left to right, the raw material wiper 50 pushes the powdery raw material from the raw material tank 12 into the printing tank 11, and afterwards the light beam emitting end 611 moves thereacross and scans the printing tank 11. The light beam emitting end 611 emits a sintering light beam. The sintering light beam passes through a light-passing opening 22 formed on the movable seat 20 (referring to FIG. 10) and spots on the raw material spread on the printing tank 11. The raw material is molten by the sintering light beam and then solidified to form the designed layer of the product.

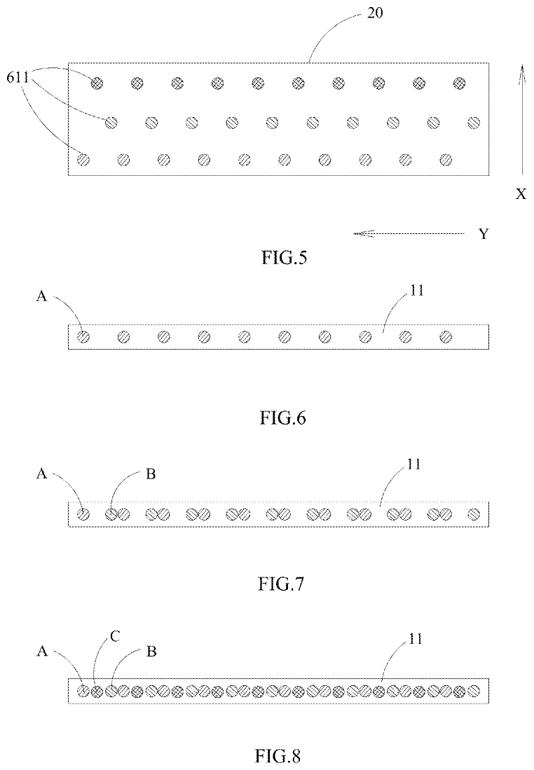

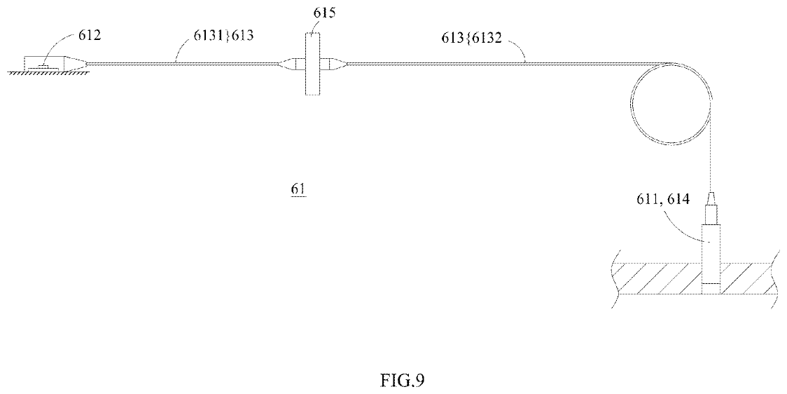

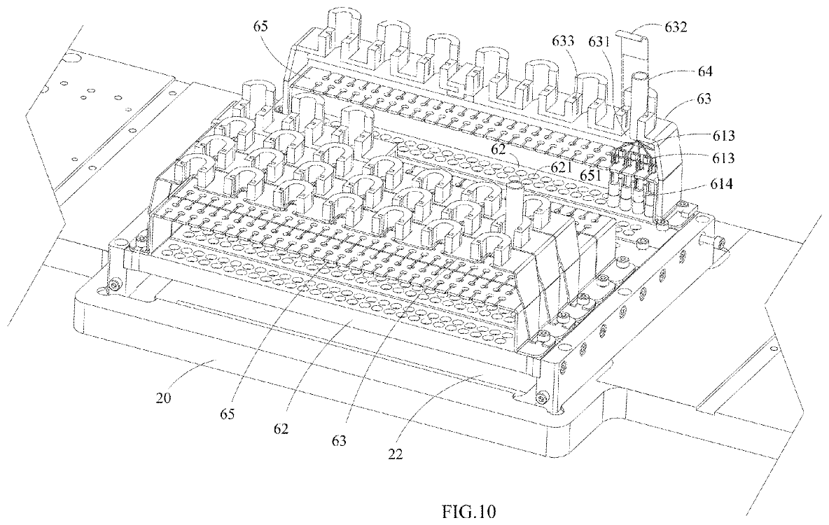

Referring to FIGS. 5, 6, 7 and 8, the light beam emitting ends 611 of the sintering light source assemblies 61 are arranged in a plurality of rows oriented along a second direction Y perpendicular to the first direction X. Each light beam emitting end 611 in one row is unaligned with the light beam emitting ends 611 in adjacent rows in the first direction X. The two-dimensional array of the light beam emitting ends 611 moves along the first direction X during the additive manufacturing process. As shown in FIG. 6, when the first row of the light beam emitting ends 611 passes through a one-dimensional printing region oriented in the second direction Y, the laser beam from light beam emitting ends 611 sinters the raw material in some specific positions, whereby a shaped region A is formed. Afterwards, as shown in FIG. 7, when the second row of the light beam emitting ends 611 passes through the same one-dimensional printing region, the laser beam from the light beam emitting ends 611 sinters the raw material in other specific positions, whereby a shaped region B is formed. Similarly, as shown in FIG. 8, when the third row of the light beam emitting ends 611 passes through the same one-dimensional printing region, the laser beam from the light beam emitting ends 611 sinters the raw material in yet other positions, whereby a shaped region C is formed. Therefore, as the three rows of the light beam emitting ends 611 forms the shaped regions A, B and C, a desired shape constituted by the shaped regions A, B and C oriented in the second direction Y is formed. In this way, when the two-dimensional array of the light beam emitting ends 611 moves along the first direction X, a desired shape of a layer is formed by combination of multiple shapes formed in multiple one-dimensional printing regions oriented in the second direction Y. Therefore, the two-dimensional array of the light beam emitting ends 611 moves in one stroke can completely form the whole structure of one layer of the product, thereby realizing an additive manufacturing process of high forming rate. The two-dimensional array of the light beam emitting ends 611 includes hundreds of light beam emitting ends 611. The structure of the light source assembly 61 and the structure for securing the light source assembly 61 to the sintering module 60 is described as follows.

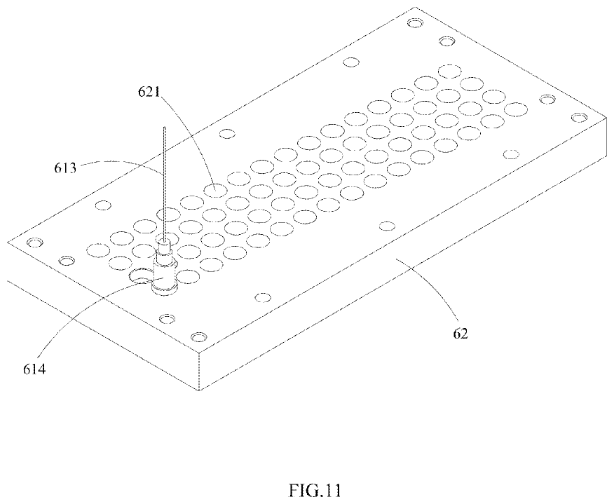

Referring to FIG. 9, an embodiment of the light source assembly 61 of the sintering module 60 is disclosed. Each light source assembly 61 includes a light emitting member 612, a light beam guiding member 613 and an optical collimator 614. The optical collimator 614 is disposed at the light beam emitting end 611. The light emitting member 612 emits a light, and the emitted light is guided by the light beam guiding member 613 to pass through the optical collimator 614 so as to form the sintering light beam. The light emitting member 612 of the present embodiment is a laser diode, the light beam guiding member 613 of the present embodiment is an optical fiber, and the optical collimator 614 includes a lens set. Each light source assembly 61 further includes an adapter 615. The light beam guiding member 613 includes a first guiding section 6131 and a second guiding section 6132. The first guiding section 6131 is connected to the light emitting member 612 at one end, and the second guiding section 6132 is connected to the optical collimator 614 at one end. The first guiding section 6131 is connected to the adapter 615 through a connector at the other end, and the second guiding section 6132 is also connected to the adapter 615 through a connector at the other end. The connector is exemplarily a FC/PC connector. The first guiding section 6131 and the second guiding section 6132 is connected to the adapter 615 through FC/PC connectors. As the light beam guiding member 613 is constituted by the first guiding section 6131 and the second guiding section 6132, the part related to the light emitting member 612 (the first guiding section 6131) or the part related to the optical collimator 614 (the second guiding section 6132) is selectively replaced depending on the maintenance condition. It is not necessary to replace the entire light beam guiding member 613 as what is done for the conventional equipment, thereby reducing the maintenance cost.

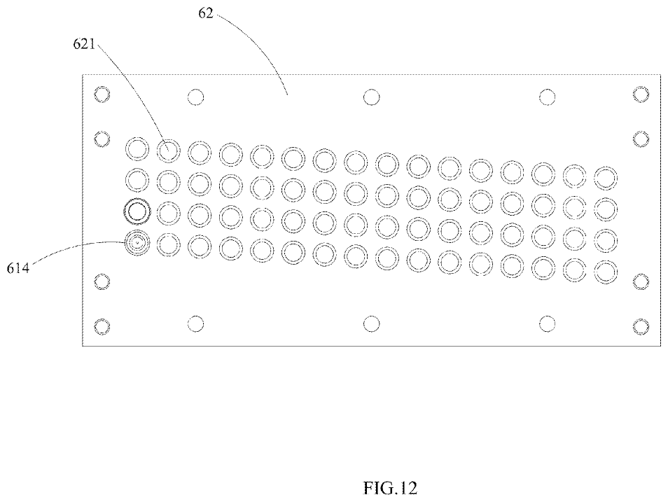

Referring to FIGS. 10, 11 and 12, the sintering module 60 further includes a collimator holder 62 which is plate-shaped, disposed in the movable seat 20 and parallel with the product carrying member 30. The collimator holder 62 has a plurality of first positioning holes 621 in which the optical collimators 614 are disposed respectively. The first positioning holes 621 correspond to the light-passing opening 22 of the movable seat 20, whereby the sintering light beam passes through the light-passing opening 22 and spots on the powdery raw material in the printing tank 11. The first positioning holes 621 are arranged in a plurality of rows to constitute a two-dimensional array. Each first positioning hole 621 in one row is unaligned with the first positioning holes 621 in adjacent rows along the first direction X, whereby the optical collimators 614 are arranged in a manner that each optical collimator 614 in one row is unaligned with the optical collimators 614 in other rows along the first direction X.

The sintering module 60 further includes a guiding member holder 63 disposed on the movable seat 20 and located above the collimator holder 62. The guiding member holder 63 has a plurality of second positioning holes 631. One second positioning hole 631 corresponds to a plurality of first positioning holes 621. A plurality of the light beam guiding members 612 connected to a plurality of the optical collimators 614 are collectively accommodated in one second positioning hole 631. Therefore, each second positioning hole 631 accommodates a plurality of the light beam guiding members 612. In the present embodiment, each second positioning hole 631 accommodates eight pieces of the light beam guiding member 612. Moreover, the sintering module 60 further includes a plurality of bundling members 64. Each bundling member 64 bundles a plurality of light beam guiding members 613 in one second positioning hole 631. The guiding member holder 63 further includes a plurality of securing plates 632. Slots 633 are formed on opposite inner walls of each second positioning hole 631, and the securing plate 632 is inserted into the slots 633, whereby the securing plate 632 and the inner walls of the second positioning hole 631 hold the bundling member 64 to secure the bundling member 64 in the second positioning hole 631.

The sintering module 60 further includes an assistant holder 65 disposed above the collimator holder 62 and located between the collimator holder 62 and the guiding member holder 63. The assistant holder 65 has a plurality of third positioning holes 651 aligned with the first positioning holes 621. The end of the optical collimator 614 connected to the light beam guiding member 613 is disposed in the third positioning hole 651, whereby the optical collimator 614 is positioned in the collimator holder 62 and the assistant holder 65.

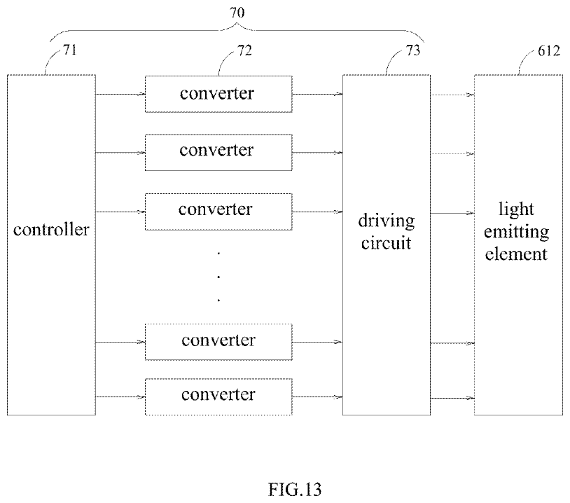

Referring to FIG. 13, the high-speed additive manufacturing apparatus of the present embodiment further includes a control module 70. The control module 70 includes a controller 71, a plurality of converters 72 and a plurality of driving circuits 73. The controller 71 has a plurality of input-output ports, and the converters 72 are connected to the input-output ports and the driving circuits 73. The driving circuits 73 drive the light emitting members 612. The controller 71 of the present embodiment is the digital output module R1-EC70X2 produced by Delta Electronics. Inc., which has thirty-two input-output ports. The controller 71 outputs control signals through the input-output ports according to a timing scheme. The control signals are converted to driving signals by the converters 72. The driving signals are transmitted to the driving circuits 73 to drive the light emitting members 612. The converter 72 of the present embodiment is the chip of Tamega 2560, which converts the digital control signals from the controller 71 to pulse width modulation (PWM) signals, thereby driving the light emitting member 612.

Referring to FIG. 4 again, the high-speed additive manufacturing apparatus of the present embodiment further includes a position detector 80 disposed on the main body 10 and the movable seat 20. The position detector 80 is configured to detect the position of the movable seat 20 (light beam emitting end 611) and generate a detecting signal which is transmitted to the controller 71. The controller 71 generates the control signal according to the detecting signal, i.e. the controller 71 generates the control signals to control light intensity of the light emitting members 612 according to the position of the movable seat 20 detected by the position detector 80. The position detector 80 of the present embodiment is an optical ruler.

The high-speed additive manufacturing apparatus of the present embodiment further includes a human-machine interface including a stepping mode and a moving mode. The human-machine interface is executed by application program installed in the apparatus and displayed on a display device. A user can input operation parameters through the human-machine interface, such as the moving speeds and displacements of the movable seat 20, the product carrying member 30 and the raw material carrying member 40 in each stroke.

The high-speed additive manufacturing apparatus of the present invention includes a two-dimensional array of sintering light source assemblies of which the light beam emitting ends in adjacent rows are unaligned, and the light beam emitting ends can scan multiple linear regions constituting one designed layer. After the two-dimensional array of the light beam emitting ends of the sintering module moves along the first direction only in one stroke, one designed layer of the product is accomplished. Therefore, the product is manufactured by the high-speed additive manufacturing apparatus of the present invention at a very high forming rate.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A high-speed additive manufacturing apparatus, comprising:
a main body comprising a printing tank and a raw material tank adjacent to the printing tank;
a sintering module comprising a plurality of sintering light source assemblies, wherein each of the sintering light source assemblies has a light beam emitting end disposed in the main body, the light beam emitting end emits a sintering light beam, the light beam emitting end is configured to move above the printing tank along a first direction, the light beam emitting ends of the sintering light source assemblies are arranged in a plurality of rows oriented along a second direction perpendicular to the first direction, and each of the light beam emitting ends in one row is unaligned with the light beam emitting ends in adjacent rows along the first direction;
a product carrying member disposed in the printing tank, wherein a product is formed on the product carrying member, and the product carrying member is configured to move along a third direction in the printing tank;
a raw material carrying member disposed in the raw material tank, wherein the raw material carrying member is configured to move along the third direction in the raw material tank; and
a raw material wiper configured to move in the printing tank and the raw material tank.

2. The high-speed additive manufacturing apparatus as claimed in claim 1, wherein each of the sintering light source assemblies comprises a light emitting member, a light beam guiding member and an optical collimator disposed at the light beam emitting end, the light emitting member emits a light guided by the light beam guiding member to pass through the optical collimator so as to form the sintering light beam.

3. The high-speed additive manufacturing apparatus as claimed in claim 2, wherein each of the sintering light source assemblies further comprises an adapter, the light beam guiding member comprises a first guiding section connected to the light emitting member at one end, and a second guiding section connected to the optical collimator at one end, the first guiding section is connected to the adapter at the other end, and the second guiding section is connected to the adapter at the other end.

4. The high-speed additive manufacturing apparatus as claimed in claim 2, wherein the sintering module further comprises a collimator holder parallel to the product carrying member, the collimator holder has a plurality of first positioning holes in which the optical collimators are disposed respectively, the first positioning holes are arranged in a plurality of rows, and each of the first positioning holes in one row is unaligned with the first positioning holes in adjacent rows in the first direction.

5. The high-speed additive manufacturing apparatus as claimed in claim 4, wherein the sintering module further comprises a guiding member holder having a plurality of second positioning holes, each of the second positioning holes corresponds to a plurality of the first positioning holes, and each of the second positioning holes accommodates a plurality of light beam guiding members.

6. The high-speed additive manufacturing apparatus as claimed in claim 5, wherein the guiding member holder is disposed above the collimator holder, the guiding member holder comprises a plurality of securing plates correspondingly disposed in the second positioning holes, the sintering module further comprises a plurality of bundling members corresponding to the second positioning holes, a plurality of the light beam guiding members are bundled by one of the bundling members and disposed in one of the second positioning holes, and each of the securing plates secures one of the bundling members in one of the second positioning holes.

7. The high-speed additive manufacturing apparatus as claimed in claim 5, wherein the sintering module further comprises a movable seat configured to move along the first direction on the main body, the collimator holder and the guiding member holder are disposed on the movable seat, the movable seat has a light-passing opening corresponding to the first positioning holes, and the raw material wiper is disposed on one side of the movable seat.

8. The high-speed additive manufacturing apparatus as claimed in claim 2, further comprising a control module, wherein the control module comprises a controller, a plurality of converters and a plurality of driving circuits, the controller has a plurality of input-output ports, the converters are connected to the input-output ports and the driving circuits, the driving circuits drive the light emitting members, the controller outputs control signals through the input-output ports according to a timing scheme, and the control signals are converted to driving signals transmitted to the driving circuits to drive the light emitting members.

9. The high-speed additive manufacturing apparatus as claimed in claim 7, wherein the control signals are digital signals, and the driving signals are pulse width modulation signals.

10. The high-speed additive manufacturing apparatus as claimed in claim 7, further comprising a position detector disposed in the main body and configured to detect a position of the light beam emitting end and generate a detecting signal transmitted to the controller, the controller generates the control signals according to the detecting signal.
